(19) United States
(12) Patent Application Publication
(10) Pub. No.: US 2008/0238355 A1
(43) Pub. Date: Oct. 2, 2008

(54) FUEL CELL SYSTEM AND OPERATION METHOD THEREFOR

(75) Inventor: Yasuyuki MURAMATSU, Shizuoka (JP)

Correspondence Address: YAMAHA HATSUDOKI KABUSHIKI KAISHA;C/O KEATING & BENNETT, LLP, 1800 Alexander Bell Drive, SUITE 200, Reston, VA, 20191, US

(73) Assignee: YAMAHA HATSUDOKI KABUSHIKI KAISHA, Iwata-shi (JP)

(21) Appl. No.: 12/054,708

(22) Filed: Mar. 25, 2008

(30) Foreign Application Priority Data
Mar. 26, 2007 (JP) 2007-79925

(51) Int. Cl. H02J 7/00

(52) U.S. Cl. 320/101; 320/150; 320/138; 320/155

(57) ABSTRACT

A motorbike is mounted with a fuel cell system which includes a cell stack, a secondary battery which is charged by the cell stack and a controller which has a CPU. After receiving an operation stop command which is issued from a main switch, the CPU estimates a charging time for a charge rate of the secondary battery to attain a target value, based on a voltage of the secondary battery and a charge current which are detected based on detection signals from a voltage detection circuit and an electric current detection circuit, as well as based on a charging time estimation table stored in a memory. The charging time estimated by the CPU is displayed in a display.

### BACKGROUND OF THE INVENTION

1. Field of the Invention

The present invention relates to a fuel cell system and an operation method therefor, and more specifically, to a fuel cell system in which a secondary battery is charged by the fuel cell, and to an operation method therefor.

2. Description of the Related Art

In general, there is known a fuel cell system which supplies power to an external load, from at least one of the fuel cell and a secondary battery. For example, JP-A 10-40931 discloses a fuel cell system in which, after an issuance of an operation stop command, a secondary battery is charged by the fuel cell until the amount of charge in the secondary battery reaches a target value in order to ensure reliable operation the next time.

In the case where charging is performed after an issuance of an operation stop command as in the technique disclosed in JP-A 10-40931, a human operator is required to attend to the fuel cell system in order to monitor the charging process until the process comes to an end, so as to prevent the fuel cell system from malfunctioning in case of an abnormality.

However, according to the technique in JP-A 10-40931, the operator must attend to the process without any idea about when the charging process after the issuance of the operation stop command will be completed. This prevents the operator from making a schedule for the next activity. In other words, there has not been good operator convenience.

### SUMMARY OF THE INVENTION

In order to overcome the problems described above, preferred embodiments of the present invention provide a fuel cell system capable of improving operator convenience, and an operation method therefor.

According to a preferred embodiment of the present invention, a fuel cell system includes a fuel cell; a secondary battery which is charged by the fuel cell; a charge amount information detector arranged to detect charge amount information regarding the amount of charge in the secondary battery; an electric current information detector arranged to detect electric current information regarding an electric current flowing in the secondary battery; a first estimation unit arranged to estimate a charging time for an amount of charge in the secondary battery to reach a target value, based on a result of detection by the charge amount information detector and a result of detection by the electric current information detector; and a notification unit arranged to notify a result of estimation by the first estimation unit.

According to another preferred embodiment of the present invention, a method for operating a fuel cell system including a fuel cell and a secondary battery which is charged by the fuel cell includes a step of charging the secondary battery by the fuel cell; a step of detecting charge amount information regarding an amount of charge in the secondary battery; a step of detecting electric current information regarding an electric current flowing in the secondary battery; a step of estimating a charging time for the amount of charge in the secondary battery to attain a target value based on the charge amount information and the electric current information which are detected; and a step of notifying the estimated charging time.

According to preferred embodiments of the present invention described above, it is possible to estimate a charging time for the amount of charge in the secondary battery to attain a target value based on charge amount information regarding the amount of charge in the secondary battery and electric current information regarding the electric current which flows in the secondary battery, and to notify the estimated charging time to an operator. Therefore, the operator can schedule his next activity during the charging process after issuance of operation stop command, and it is possible to improve operator convenience.

Preferably, the fuel cell system further includes a setting unit arranged to set one of a state of connection in which the fuel cell is connected with an external load and a state of disconnection in which the fuel cell is not connected with the external load. With this arrangement, the first estimation unit estimates the charging time after the setting unit has made a setting into the state of disconnection. The external load such as a motor has a large fluctuation in its power consumption. For this reason, the electric current which flows in the secondary battery also has a large fluctuation in the state of connection where the fuel cell is connected with the external load. Compared to this, in the state of disconnection where the fuel cell is not connected with the external load, the only power consumption is power consumed by the system components such as various pumps which are driven for power generation in the fuel cell, and therefore the fluctuation of the electric current which flows in the secondary battery is also small. Therefore, by estimating the charging time after a setting has been made to the state of disconnection, it becomes possible to estimate the charging time under a condition where the electric current which flows in the secondary battery also has a small fluctuation, making it possible to improve reliability of the result of estimation.

The fuel cell system makes a shift to normal operation where the fuel cell can generate power constantly, when the temperature of the fuel cell has increased to attain a predetermined temperature. Before the fuel cell attains a predetermined temperature, the system components receive power from the secondary battery, and thus the amount of charge in the secondary battery decreases once. Thereafter, as the fuel cell temperature increases, output of the fuel cell becomes able to cover the power consumption of the system components and to charge secondary battery, so the amount of charge in the secondary battery increases.

Preferably, a preferred embodiment of the present invention further includes a temperature detector arranged to detect a temperature of the fuel cell; a first memory which stores an output of the fuel cell; and a second memory which stores a recovery time estimation table that shows correspondence between the temperature of the fuel cell, the output of the fuel cell and a recovery time for the temperature of the fuel cell to attain a target temperature. With the above arrangement, the first estimation unit estimates the recovery time based on a result of detection by the temperature detector, the output stored in the first memory and the recovery time estimation table stored in the second memory; detects the electric current information based on the output stored in the first memory; estimates the charging time based on the detected electric current information, the estimated recovery time and a result of detection by the charge amount information detector; and obtains the estimated result by adding the estimated recovery time to the estimated charging time, if a result of detection by the temperature detector is lower than a predetermined temperature. In other words, if the fuel cell's temperature is lower than the predetermined temperature, an estimation is made for a recovery time for the fuel cell's temperature to attain the target temperature, based on the temperature of the fuel cell, an output value of the fuel cell which is stored in the first memory, and a recovery time estimation table which is prepared in advance. Then, based on output of the fuel cell which is stored in the first memory, calculation is made to obtain electric current information regarding the electric current which flows in secondary battery. Then, based on the detected electric current information, the estimated recovery time and charge amount information regarding the amount of charge in the secondary battery, estimation is made for a charging time for the amount of charge in the secondary battery to attain a target value. Then, the estimated charging time is added to the estimated recovery time, and the result is notified as a result of estimation. With this arrangement, it becomes possible to notify the time necessary for the charging process after issuance of operation stop command even if the fuel cell's temperature is lower than the predetermined temperature. In other words, it is possible to notify the time necessary for the charging process after issuance of an operation stop command even if the fuel cell system is not in the normal operation.

Further preferably, the target value includes a first target value which is greater than a value at which the fuel cell can make a shift to normal operation where the fuel cell can generate power constantly, and a second target value which is smaller than the first target value. In this case, estimation is made for a charging time for the amount of charge in the secondary battery to attain the first target value, and a charging time for the amount of charge in the secondary battery to attain the second target value. Then, these two charging times are notified to the operator. This arrangement allows the operator to choose which of the charging times he wants to use to complete the charging process after issuance of operation stop command. This makes it possible to further improve the operator convenience.

Further, preferably, the second target value is set to a value at which shifting to the normal operation is possible. By setting the second target value to a minimum necessary value for a shift to normal operation the next time the system is operated as described, it becomes possible to notify a minimum necessary charging time (the minimum charging time).

Preferably, the second target value is set to a value at which an electric current flow in the secondary battery in a case of charging by an external power source which is capable of charging the secondary battery with a predetermined electric current is identical with an electric current flow in the secondary battery in a case of charging by the fuel cell. In the case of charging by the fuel cell, the voltage in the secondary battery increases whereas the current which flows in the secondary battery decreases as the amount of charge in the secondary battery increases. On the contrary, the external power source, which is provided by a commercial source of electricity, for example, can charge the secondary battery with a constant current. For this reason, as the amount of charge increases, the current which flows in the secondary battery becomes larger in the charging by an external power source than in the charging by the fuel cell, making possible to shorten the charging time. As described above, the second target value is set to a value at which an electric current flow in the secondary battery in a case of charging by an external power source is identical with an electric current flow in the secondary battery in a case of charging by the fuel cell. Under this setting, once the second target value is reached, then at any later time point, the electric current which flows in the secondary battery in the case of charging by the external power source is larger than in the case of charging by the fuel cell, so this setting makes it possible to notify a charging time (switch-over charging time) at which switching should be made to charging by the external power source.

Further preferably, the fuel cell system further includes a second estimation unit which estimates the charging time for a case of charging by an external power source which is capable of charging the secondary battery with a predetermined electric current, based on a result of detection by the charge amount information detector and the predetermined electric current. With the above configuration, the notification unit notifies a result of estimation by the first estimation unit and a result of estimation by the second estimation unit. By notifying the operator of a charging time in the case of charging by the fuel cell and a charging time in the case of charging by the external power source as described above, the operator can choose which of the methods he would like to use for the charging. This makes it possible to further improve the operator convenience.

Further, preferably, the fuel cell system further includes a connection determination unit which determines whether or not the external power source is connected; a comparison unit which compares a result of estimation by the first estimation unit and a result of estimation by the second estimation unit; and a switch which switches from charging by the fuel cell to charging by the external power source based on a result of determination by the connection determination unit and a result of comparison by the comparison unit. In this case, if the charging by an external power source requires a shorter charging time than the charging by the fuel cell, a change is made automatically, from the charging by the fuel cell to the charging by the external power source. This makes it possible to shorten the time necessary for the charging process after issuance of operation stop command.

Normally, it is assumable that drivers of transportation equipment already have a schedule for the time after their arrival at their destinations before they arrive at their destinations. For this reason, the drivers of transportation equipment will have to be under a considerable burden if they have to wait without an idea when the charging will be finished after their arrival at their destinations. Since preferred embodiments of the present invention make it possible to let them know the charging time, the fuel cell systems according to various preferred embodiments of the present invention are applicable suitably to transportation equipment.

In the description of preferred embodiments of present invention, the term “charge amount information regarding the amount of charge” of the secondary battery refers to information which has a specific relationship with the amount of charge in the secondary battery, including, for example, an amount of charge per se, a charge rate and a voltage of the secondary battery.

The above-described and other elements, features, steps, characteristics, aspects and advantages of the present invention will become more apparent from the following detailed description of preferred embodiments to be made with reference to the attached drawings.

### BRIEF DESCRIPTION OF THE DRAWINGS

FIG. 1 is a left side view showing a motorbike according to a preferred embodiment of the present invention.

FIG. 2 is a system diagram showing piping in the fuel cell system according to a preferred embodiment of the present invention.

FIG. 3 is a block diagram showing an electrical configuration of the fuel cell system according to a preferred embodiment of the present invention.

FIG. 4 is a graph showing a charging characteristic of a secondary battery.

FIG. 5 is a graph showing an output characteristic of a cell stack.

FIG. 6 is a graph showing a relationship between a voltage of the secondary battery and a charge current in a case where charging is performed by a cell stack and a case where charging is performed by an external power source.

FIG. 7 is a graph showing a relationship between the charge rate, a temperature of a cell stack and a recovery time.

FIG. 8 is a flowchart showing an example of charging process in the fuel cell system according to a preferred embodiment of the present invention from the time of an operation start command to the time of an operation stop command.

FIG. 9 is a flowchart showing an example of charging process in the fuel cell system according to a preferred embodiment of the present invention after an issuance of the operation stop command.

FIG. 10 is a flowchart showing a continued part of the process in FIG. 9.

FIG. 11 is a graph showing a relationship between a temperature of the cell stack and an output of the cell stack.

FIG. 12 is a graph showing a relationship between a current in the cell stack and a charge current.

### DETAILED DESCRIPTION OF THE PREFERRED EMBODIMENTS

Hereinafter, preferred embodiments of the present invention will be described, with reference to the drawings.

The preferred embodiments are cases in which a fuel cell system 100 according to the present invention is preferably provided in a motorbike 10 as an example of transportation equipment.

The description will first cover the motorbike 10. It is noted that the terms left and right, front and rear, up and down as used in the description of preferred embodiments of the present invention are determined from the normal state of riding, i.e., as viewed by the driver sitting on the driver's seat of the motorbike 10, with the driver facing toward a handle 24.

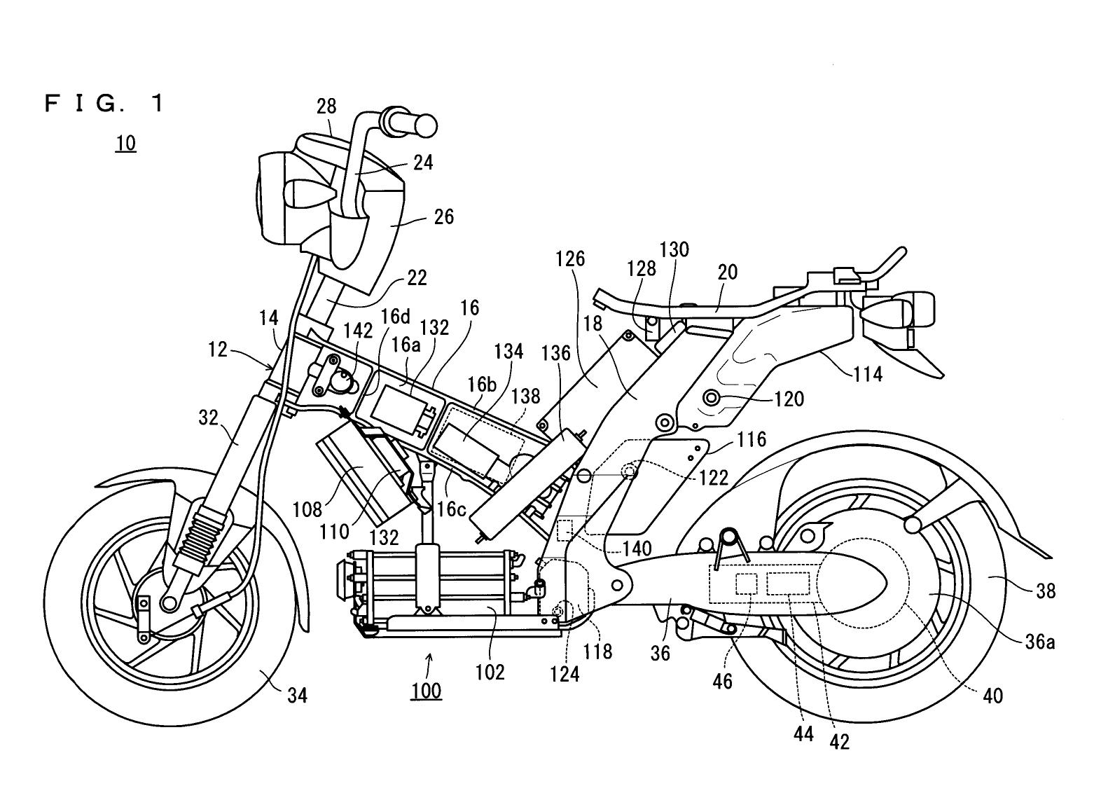

Referring to FIG. 1, the motorbike 10 preferably includes a vehicle frame 12. The vehicle frame 12 has a head pipe 14, a front frame 16 which has an I-shaped vertical section and extends in a rearward and downward direction from the head pipe 14, and a rear frame 18 which is connected with a rear end of the front frame 16 and rising in a rearward and upward direction.

The front frame 16 preferably includes a plate member 16a which has a width in the vertical direction and extends in a rearward and downward direction, substantially perpendicularly to the lateral directions of the vehicle; flanges 16b, 16c which are located respectively at an upper end edge and a lower end edge of the plate member 16a, and extending in a rearward and downward direction and have a width in the lateral directions; and reinforcing ribs 16d protruding from both surfaces of the plate member 16a. The reinforcing ribs 16d and the flanges 16b, 16c define storage walls, providing compartments on both surfaces of the plate member 16a defining storage spaces for components of the fuel cell system 100 to be described later.

The rear frame 18 preferably includes a pair of left and right plate members each having a width in the front and rear directions, extending in a rearward and upward direction, and sandwiching a rear end of the front frame 16. The pair of plate members of the rear frame 18 have their upper end portions provided with seat rails 20 fixed thereto, for installation of an unillustrated seat. Note that FIG. 1 shows the left plate member of the rear frame 18.

A steering shaft 22 is pivotably inserted in the head pipe 14. A handle support 26 is provided at an upper end of the steering shaft 22, to which the handle 24 is fixed. The handle support 26 has an upper end provided with a display/operation board 28.

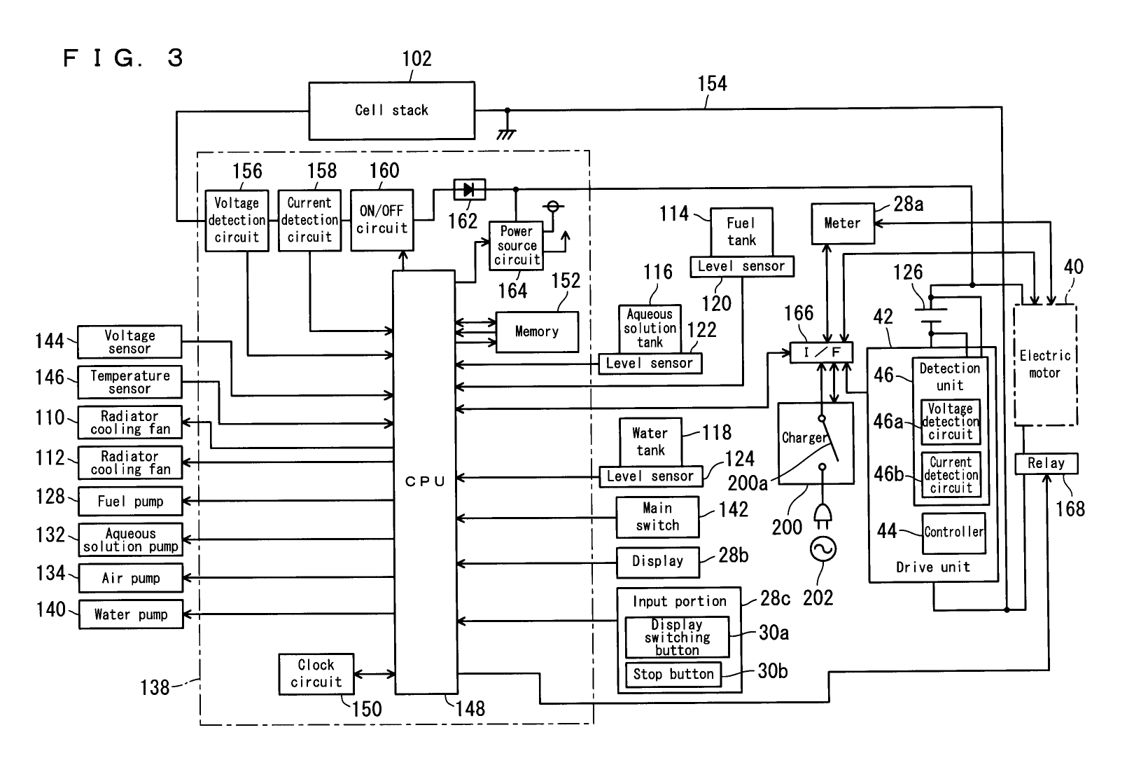

Referring also to FIG. 3, the display/operation board 28 preferably is an integrated dashboard including a meter 28a for measuring and displaying various data concerning an electric motor 40 (to be described later); a display 28b provided by, e.g., a liquid crystal display for providing the driver with a variety of information; and an input portion 28c for inputting a variety of commands and data. The input portion 28c includes a display switching button 30a for switching a charging time displayed in the display 28b and a stop button 30b for issuing a power generation stop command of a fuel cell stack (hereinafter simply called cell stack) 102.

As shown in FIG. 1, a pair of left and right front forks 32 extend from a bottom end of the steering shaft 22. Each of the front forks 32 includes a bottom end rotatably supporting a front wheel 34.

The rear frame 18 includes a lower end which pivotably supports a swing arm (rear arm) 36. The swing arm 36 has a rear end 36a incorporating the electric motor 40 of an axial gap type, for example, which is connected with the rear wheel 38 to rotate the rear wheel 38. The swing arm 36 also incorporates a drive unit 42 which is electrically connected with the electric motor 40. The drive unit 42 includes a motor controller 44 for controlling the rotating drive of the electric motor 40, and a detection unit 46 for detecting the state of charge in the secondary battery 126 (to be described later). The detection unit 46 includes a voltage detection circuit 46a for detecting the end-to-end voltage of the secondary battery 126 and an electric current detection circuit 46b for detecting the current which flows in the secondary battery 126 (see FIG. 3).

The motorbike 10 as described is equipped with a fuel cell system 100, with its constituent members being disposed along the vehicle frame 12. The fuel cell system 100 generates electric energy for driving the electric motor 40 and other system components.

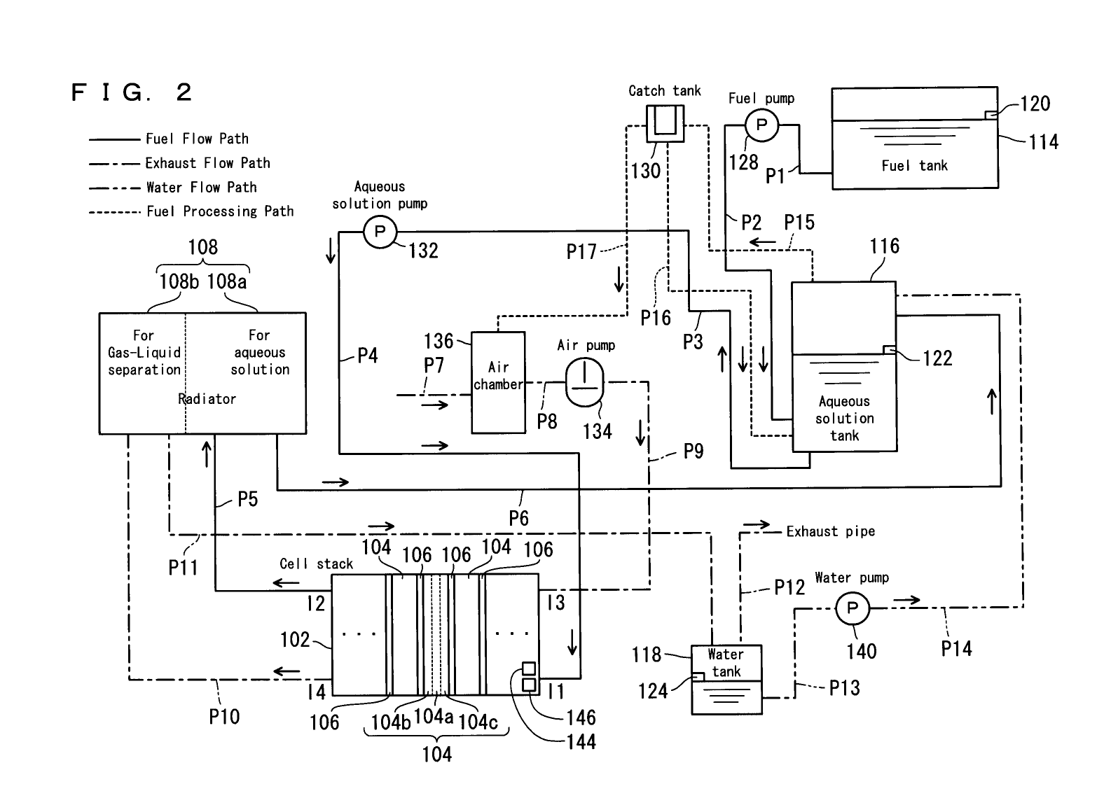

Hereinafter, the fuel cell system 100 will be described, with reference to FIG. 1 and FIG. 2.

The fuel cell system 100 is preferably a direct methanol fuel cell system which uses methanol (an aqueous solution of methanol) directly without reformation, for generation of electric energy (power generation).

The fuel cell system 100 includes the cell stack 102. As shown in FIG. 1, the cell stack 102 is suspended from the flange 16c, and is disposed below the front frame 16.

As shown in FIG. 2, the cell stack 102 includes a plurality of fuel cells (individual fuel cells) 104 layered (stacked) alternately with separators 106. Each fuel cell 104 is capable of generating electric power through electrochemical reactions between hydrogen ion based on methanol and oxygen. Each fuel cell 104 in the cell stack 102 includes an electrolyte film 104a, such as a solid polymer film, for example, and a pair of an anode (fuel electrode) 104b and a cathode (air electrode) 104c opposed to each other, with the electrolyte film 104a in between. The anode 104b and the cathode 104c each include a platinum catalyst layer provided on the side closer to the electrolyte film 104a.

As shown in FIG. 1, a radiator unit 108 is disposed below the front frame 16, above the cell stack 102.

As shown in FIG. 2, the radiator unit 108 includes integrally therein, a radiator 108a for aqueous solution and a radiator 108b for gas-liquid separation. On a back side of the radiator unit 108, there is a fan 110 provided to cool the radiator 108a, and there is another fan 112 (see FIG. 3) provided to cool the radiator 108b. In FIG. 1, the radiators 108a and 108b are disposed side by side, with one on the left-hand side and the other on the right-hand side, and the figure shows the fan 110 for cooling the left-hand side radiator 108a.

A fuel tank 114, an aqueous solution tank 116 and a water tank 118 are disposed in this order from top to bottom, between the pair of plate members in the rear frame 18.

The fuel tank 114 contains a methanol fuel (high concentration aqueous solution of methanol) having a high concentration level (containing methanol at approximately 50 wt %, for example) which is used as fuel for the electrochemical reaction in the cell stack 102. The aqueous solution tank 116 contains aqueous methanol solution, which is a solution of the methanol fuel from the fuel tank 114 diluted to a suitable concentration (containing methanol at approximately 3 wt %, for example) for the electrochemical reaction in the cell stack 102. The water tank 118 contains water which is produced in association with the electrochemical reaction in the cell stack 102.

The fuel tank 114 is provided with a level sensor 120 while the aqueous solution tank 116 is provided with a level sensor 122, and the water tank 118 is provided with a level sensor 124. The level sensors 120, 122 and 124 preferably are float sensors each having an unillustrated float, for example, in order to detect the height of liquid (liquid level) in the respective tanks.

In front of the fuel tank 114 and above the front frame 16 is the secondary battery 126 such as a lithium ion battery. The secondary battery 126 stores the electric power from the cell stack 102, and supplies the electric power to the electric components in response to commands from a controller 138 (to be described later). Above the secondary battery 126, a fuel pump 128 is disposed. Further, a catch tank 130 is disposed in front of the fuel tank 114, i.e., above and behind the secondary battery 126.

An aqueous solution pump 132 and an air pump 134 are housed in the storage space on the left side of the front frame 16. On the left side of the air pump 134 is an air chamber 136. The controller 138 and a water pump 140 are disposed in the storage space on the right side of the front frame 16.

Further, a main switch 142 is provided in the front frame 16, penetrating the storage space in the front frame 16 from right to left. Turning on the main switch 142 provides an operation start command to the controller 138 and turning off the main switch 142 provides an operation stop command to the controller 138.

As shown in FIG. 2, the fuel tank 114 and the fuel pump 128 are connected with each other by a pipe P1. The fuel pump 128 and the aqueous solution tank 116 are connected with each other by a pipe P2. The aqueous solution tank 116 and the aqueous solution pump 132 are connected with each other by a pipe P3. The aqueous solution pump 132 and the cell stack 102 are connected with each other by a pipe P4. The pipe P4 is connected with an anode inlet I1 of the cell stack 102. By driving the aqueous solution pump 132, aqueous methanol solution is supplied to the cell stack 102.

A voltage sensor 144 is provided near the anode inlet I1 of the cell stack 102 in order to detect concentration information, which reflects the concentration of aqueous methanol solution (the ratio of methanol in the aqueous methanol solution) supplied to the cell stack 102, using an electrochemical characteristic of the aqueous methanol solution. The voltage sensor 144 detects an open-circuit voltage of the fuel cell 104, and the detected voltage value defines electrochemical concentration information. Near the anode inlet I1 of the cell stack 102, a temperature sensor 146 is provided in order to detect the temperature of aqueous methanol solution supplied to the cell stack 102.

The cell stack 102 and the aqueous solution radiator 108a are connected with each other by a pipe P5, and the radiator 108a and the aqueous solution tank 116 are connected with each other by a pipe P6. The pipe P5 is connected with an anode outlet I2 of the cell stack 102.

The pipes P1 through P6 serve primarily as a flow path for fuel.

A pipe P7 is connected with the air chamber 136. The air chamber 136 and the air pump 134 are connected with each other by a pipe P8 whereas the air pump 134 and the fuel cell stack 102 are connected with each other by a pipe P9. The pipe P9 is connected with a cathode inlet 13 of the cell stack 102. By driving the air pump 134, air from outside is supplied to the cell stack 102.

The cell stack 102 and the gas-liquid separation radiator 108b are connected with each other by a pipe P10. The radiator 108b and the water tank 118 are connected with each other by a pipe P11. The water tank 118 is provided with a pipe (an exhaust pipe) P12. The pipe P10 is connected with a cathode outlet I4 of the cell stack 102. The pipe P12 is provided at an exhaust discharge outlet of the water tank 118, and discharges exhaust gas from the cell stack 102 to outside.

The pipes P7 through P12 serve primarily as a flow path for oxidizer.

The water tank 118 and the water pump 140 are connected with each other by a pipe P13 whereas the water pump 140 and the aqueous solution tank 116 are connected with each other by a pipe P14.

The pipes P13, P14 serve as a flow path for water.

The aqueous solution tank 116 and the catch tank 130 are connected with each other by pipes P15, P16. The catch tank 130 and the air chamber 136 are connected with each other by a pipe P17.

The pipes P15 through P17 constitute a flow path for fuel processing.

Next, description will be made for an electric configuration of the fuel cell system 100, with reference to FIG. 3.

The controller 138 of the fuel cell system 100 includes a CPU 148 which performs necessary calculations and controls operations in the fuel cell system 100; a clock circuit 150 which provides the CPU 148 with a clock signal; a memory 152 which may preferably be an EEPROM, for example, and stores programs and data for controlling the operation of the fuel cell system 100 as well as calculation data, etc.; a voltage detection circuit 156 for detecting a voltage in an electric circuit 154 which connects the cell stack 102 with the electric motor 40; an electric current detection circuit 158 for detecting an electric current which flows in the cell stack 102; an ON/OFF circuit 160 for opening and closing the electric circuit 154; a diode 162 which is provided in the electric circuit 154; and a power source circuit 164 for supplying a predetermined voltage to the electric circuit 154.

The CPU 148 of the controller 138 is supplied with input signals from a main switch 142 which turns ON/OFF the power source, and input signals from a display switching button 30a and a stop button 30b in the input portion 28c. Also, the CPU 148 is supplied with detection signals from level sensors 120, 122, 124, a voltage sensor 144 and a temperature sensor 146. The CPU 148 detects the amount of liquid in the fuel tank 114, the aqueous solution tank 116 and the water tank 118 based on the detection signals from the level sensors 120, 122 and 124; detects the concentration of aqueous methanol solution which is supplied to the cell stack 102, based on concentration information from the voltage sensor 144; and detects the temperature of aqueous methanol solution supplied to the cell stack 102 as the temperature of the cell stack 102 based on the detection signal from the temperature sensor 146.

Further, the CPU 148 is supplied with detection signals from the voltage detection circuit 156 and the electric current detection circuit 158. The CPU 148 detects the voltage of the electric circuit 154, i.e., the voltage of the cell stack 102 (hereinafter called cell stack voltage) based on the detection signal from the voltage detection circuit 156, and detects the current which flows through the cell stack 102 (hereinafter called cell stack current) based on the detection signal from the electric current detection circuit 158. The CPU 148 calculates the output from the cell stack 102, using the detected cell stack voltage and the cell stack current.

Further, the CPU 148 is supplied with detection signals from a voltage detection circuit 46a and an electric current detection circuit 46b via an interface circuit 166. The CPU 148 detects the end-to-end voltage of the secondary battery 126 (hereinafter called voltage of the secondary battery) based on the detection signal from the voltage detection circuit 46a, and detects the current which flows through the secondary battery 126 (hereinafter called charge current) based on the detection signal from the electric current detection circuit 46b. In other words, the CPU 148 directly detects the current which flows in the secondary battery 126 based on the detection signal from the electric current detection circuit 46b, as electric current information regarding the charge current.

The secondary battery 126 supplements the output from the cell stack 102, and is connected in parallel to the cell stack 102. The secondary battery 126 is charged with power from the cell stack 102 or an external power source 202 (to be described later), whereas it discharges and thereby supplies power to the electric motor 40, system components, etc. The secondary battery 126 has a predetermined capacity (20 Ah herein, meaning that a 100% charge rate is attained when charged at a charge current of 2 A for 10 hours).

Table 1 is a charge-rate/battery-voltage correspondence table which relates the charge rate of the secondary battery to the voltage of the secondary battery. As shown in Table 1, the charge rate and the voltage of the secondary battery increase as charging process progresses in the secondary battery 126.

TABLE 1

| | Voltage in Secondary | | | | | | | | | | |
|---|---|---|---|---|---|---|---|---|---|---|---|
| | Battery (V) | | | | | | | | | | |
| | 23 | 23.3 | 23.6 | 24 | 25 | 26 | 26.3 | 26.6 | 27 | 28 | 28.8 |
| Charge | 25 | 30 | 35 | 40 | 55 | 70 | 75 | 80 | 85 | 95 | 98 |
| Rate | | | | | | | | | | | |
| (%) | | | | | | | | | | | |

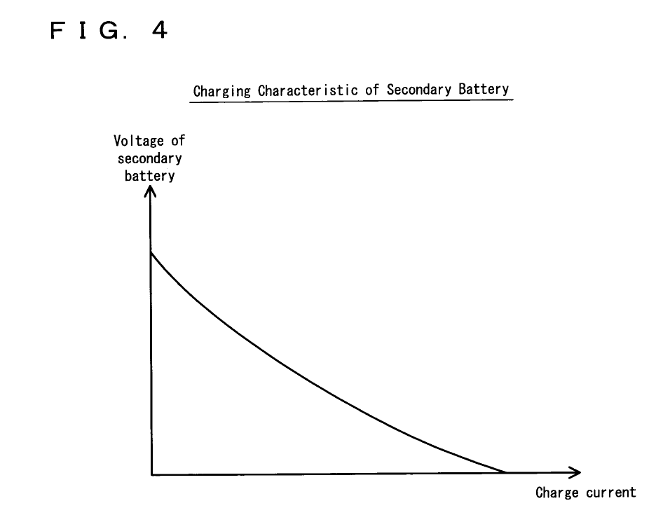

Since the voltage of the secondary battery increases with the charge rate as mentioned above, the charge current decreases as shown in FIG. 4 as the charging process progresses, in the case where the secondary battery 126 is charged by a power source which has a constant output. Such a relationship between the charge rate and the voltage of the secondary battery (see Table 1), and a relationship between the voltage of the secondary battery and the charge current (Charging characteristic: see FIG. 4) are predetermined by the kind of the secondary battery 126. The CPU 148 detects the voltage of the secondary battery based on a result of detection by the voltage detection circuit 46a, thereby virtually detecting the charge rate of the secondary battery 126.

The CPU 148 controls system components such as the fuel pump 128, the aqueous solution pump 132, the air pump 134, the water pump 140 and the fans 110, 112. Further, the CPU 148 controls the display 28b to provide the operator (the driver of the motorbike 10 in this preferred embodiment) with various kinds of information.

Also, the CPU 148 is connected with a relay switch (hereinafter simply called relay) 168. The cell stack 102, the secondary battery 126 and the drive unit 42 are connected with the electric motor 40 via the relay 168. The CPU 148 controls an ON/OFF operation of the relay 168 as the main switch 142 is turned ON/OFF. When the relay 168 is turned ON, the cell stack 102, the secondary battery 126 and the drive unit 42 are brought to a state of connection with the electric motor 40. On the other hand, when the relay 168 is turned OFF, the cell stack 102, the secondary battery 126 and the drive unit 42 are brought to a state of disconnection from the electric motor 40.

The electric motor 40 which defines the external load is connected with the meter 28a for measurement of various data concerning the electric motor 40. The data measured by the meter 28a and status information about the electric motor 40 are supplied to the CPU 148 via the interface circuit 166.

The interface circuit 166 is connectable with a charger 200. The charger 200 is connectable with an external power source 202. When the interface circuit 166 is in connection with the charger 200, and the charger 200 is in connection with the external power source 202, an external power source connection signal is supplied from the charger 200 to the CPU 148 via the interface circuit 166. Based on presence or absence of the external power source connection signal, the CPU 148 determines whether or not the external power source 202 is connected.

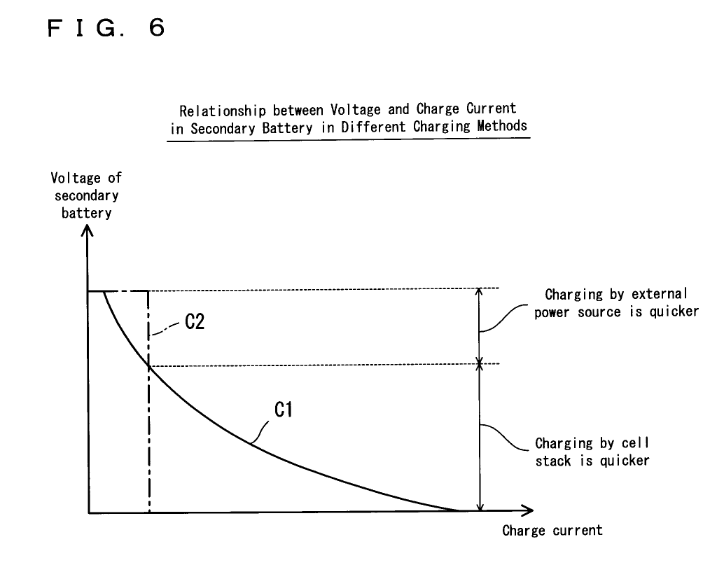

The charger 200 has a switch 200a which the CPU 148 can turn ON/OFF. When the switch 200a is ON, the secondary battery 126 is charged with power from the external power source 202. The external power source 202 is defined by a commercial source of electricity, etc., and is capable of supplying the secondary battery 126 with a predetermined current (11 A in the present preferred embodiment) regardless of the charge rate of the secondary battery 126. In other words, the external power source 202 is capable of charging the secondary battery 126 with a predetermined charge current (see C2 in FIG. 6).

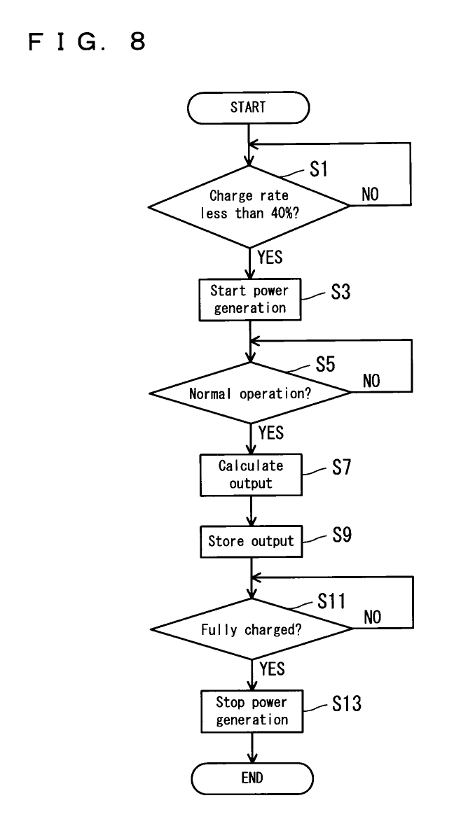

The memory 152 stores a charge-rate/battery-voltage correspondence table, a charging time estimation table, a recovery time estimation table, programs for executing processes shown in FIG. 8 through FIG. 10, the predetermined capacity of the secondary battery 126, the predetermined charge current from the external power source 202, power consumption by the system components, calculation data, and so on.

Next, description will cover the charging time estimation table stored in the memory 152, with reference to Table 2.

TABLE 2

| | Voltage in | | | | | | | | | | |
|---|---|---|---|---|---|---|---|---|---|---|---|
| | secondary Battery (V) | | | | | | | | | | |
| | 23 | 23.3 | 23.6 | 24 | 25 | 26 | 26.3 | 26.6 | 27 | 28 | 28.8 |
| Charge | 17 | 15 | 14 | 13 | 11 | 8.5 | 8 | 7.5 | 7 | 6 | — |
| current (Output | | | | | | | | | | | |
| 1) (A) | | | | | | | | | | | |
| Charge | 22 | 20 | 19 | 17 | 14 | 12 | 11.5 | 11 | 10.5 | 9.5 | — |
| current (Output | | | | | | | | | | | |
| 2) (A) | | | | | | | | | | | |
| Full | 87.7 | 84.2 | 80.2 | 75.9 | 62.1 | 45.7 | 38.6 | 31.1 | 23.1 | 6.0 | 0.0 |
| charging | | | | | | | | | | | |
| time (Output | | | | | | | | | | | |
| 1) (min) | | | | | | | | | | | |
| Full | 63.2 | 60.5 | 57.5 | 54.3 | 43.7 | 30.9 | 25.9 | 20.7 | 15.2 | 3.8 | 0.0 |
| charging | | | | | | | | | | | |
| time (Output | | | | | | | | | | | |
| 2) (min) | | | | | | | | | | | |
| Min. | 11.8 | 8.3 | 4.3 | 0.0 | — | — | — | — | — | — | — |
| charging | | | | | | | | | | | |
| time (Output | | | | | | | | | | | |
| 1) (min) | | | | | | | | | | | |
| Min. | 8.9 | 6.2 | 3.2 | 0.0 | — | — | — | — | — | — | — |
| charging | | | | | | | | | | | |
| time (Output | | | | | | | | | | | |
| 2) (min) | | | | | | | | | | | |
| Switch-over | 25.7 | 22.1 | 18.1 | 13.8 | 0.0 | — | — | — | — | — | — |
| charging | | | | | | | | | | | |
| time (Output | | | | | | | | | | | |
| 1) (min) | | | | | | | | | | | |
| Switch-over | 42.5 | 39.8 | 36.8 | 33.7 | 23.1 | 10.2 | 5.2 | 0.0 | — | — | — |
| charging | | | | | | | | | | | |
| time (Output | | | | | | | | | | | |
| 2) (min) | | | | | | | | | | | |

Output 1: Cell stack output is 550 W.
Output 2: Cell stack output is 650 W.

The charging time estimation table is used when charging of the secondary battery 126 is performed by the cell stack 102, in order to estimate the amount of charging time necessary for the amount of charge (represented by the charge rate in this preferred embodiment) of the secondary battery 126 to reach a target value, based on a detected voltage of the secondary battery and a detected charge current.

The charging time estimation table provides voltage values of the secondary battery (corresponding to the charge rate: see Table 1), charge current and charging time values corresponding to each of the voltage values of the secondary battery when the cell stack 102 under normal operation has an output of 550 W (hereinafter called Output 1), and charge current and charging time values corresponding to each of the voltage values of the secondary battery when the cell stack 102 under normal operation has an output of 650 W (hereinafter called Output 2).

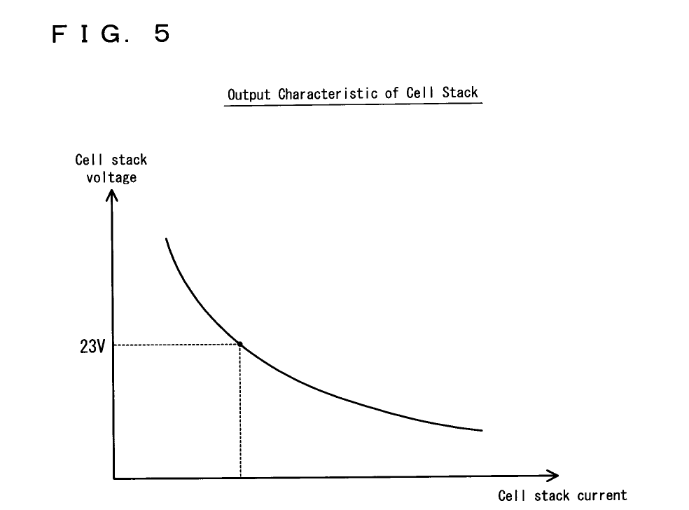

As shown in FIG. 5, the cell stack current varies with the state of power utilization (change in the cell stack voltage), and the output from the cell stack 102 varies even if the fuel cell system 100 is in normal operation where the cell stack 102 is capable of generating power constantly. In the fuel cell system 100, the predetermined cell stack voltage is 23 V, and an output when the cell stack voltage is 23 V defines the output of the cell stack 102 under normal operation.

First, description will be made for a correspondence between the voltage of the secondary battery and the charge current in the charging time estimation table.

Now, reference will also be made to FIG. 6. As shown in Table 2 and a solid line C1 in FIG. 6, the charge current decreases as the voltage of the secondary battery increases when charging is performed by using the cell stack 102. Such a correspondence between the voltage of the secondary battery and the charge current in the case of charging by the cell stack 102 is determined by the charging characteristic (see FIG. 4) of the secondary battery 126 and the output characteristic (see FIG. 5) of the cell stack 102. The charging time estimation table records measured values of the voltage in the secondary battery and of the charge current under the state of disconnection in each case of Output 1 and Output 2.

The charging time estimation table also has records for different types of the charging time, i.e., full charging time, minimum charging time and switch-over charging time.

Next, description will cover these different types of the charging time which are recorded in the charging time estimation table.

The full charging time is a charging time necessary for fully charging the secondary battery 126. In the fuel cell system 100, the CPU 148 controls the charging process so that the charge rate of the secondary battery 126 will not exceed 98% in order to prevent over-charging. Therefore, the full charging time is the amount of charging time necessary for bringing the secondary battery 126 to a charge rate of 98%.

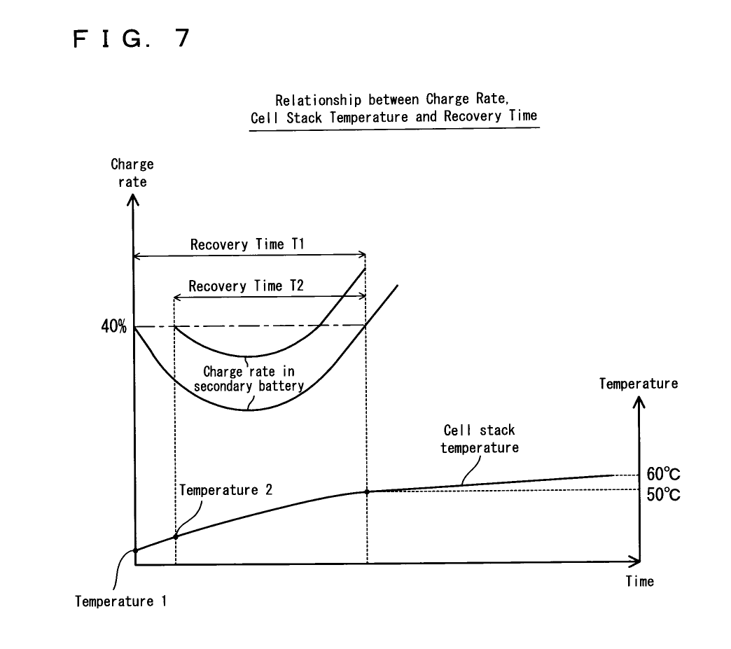

The minimum charging time is a charging time necessary for charging the secondary battery 126 to a charge rate at which the fuel cell system 100 can be shifted to normal operation. In the fuel cell system 100, the output of the cell stack 102 increases as the cell stack temperature increases. As the cell stack 102 attains a temperature of 60° C., the operation shifts to the normal operation where constant power generation is possible. When the operation is the normal operation, the output from the cell stack 102 can cover the amount of power consumed by the system components such as the aqueous solution pump 132 and the air pump 134, as well as power consumed by the electric motor 40 which defines the external load, etc. If the temperature of the cell stack 102 is low, power from the secondary battery 126 is used for driving the system components. Therefore, as shown in FIG. 7, if the temperature of the cell stack 102 is low, the charge rate of the secondary battery 126 decreases once and then increases as the temperature and the output of the cell stack 102 increases. If the charge rate of the secondary battery 126 is low, power will be depleted before the charge rate increases, and it will become impossible to maintain the operation of the fuel cell system. In the fuel cell system 100, it is possible to reliably cover the power consumption until the normal operation begins, by using power from the secondary battery 126 if the charge rate of the secondary battery 126 is 40%. Therefore, the amount of charging time necessary to bring the charge rate of the secondary battery 126 to 40% defines the minimum charging time.

The switch-over charging time is the amount of charging time necessary for the charge current from the cell stack 102 to become equal to the charge current from the external power source 202. As shown in FIG. 6, in the fuel cell system 100, the charge current in the charging process performed by the cell stack 102 (see solid line C1) is greater than the charge current in the charging process performed by the external power source 202 (rated current: see dashed line C2) if the operation is normal and the voltage of the secondary battery (the charge rate) is small. Since the charge current from the cell stack 102 decreases as the charging process progresses, the charge current in the case of charging by the cell stack 102 will eventually become equal to the charge current in the case of charging by the external power source 202. Specifically, the charge current from the external power source 202 is 11 A, and therefore, in the case of Output 1, the two charge currents become equal to each other when the voltage of the secondary battery is 25 V, and in the case of Output 2, the two charge currents become equal to each other when the voltage of the secondary battery is 26.6 V (see Table 2). Therefore, in the case of Output 1, the switch-over charging time is defined by the amount of charging time necessary for bringing the charge rate of the secondary battery 126 to 55% (which corresponds to 25 V in the voltage of the secondary battery: see Table 1). Likewise, in the case of Output 2, the switch-over charging time is defined by the amount of charging time necessary for bringing the charge rate of the secondary battery 126 to 80% (which corresponds to 26.6 V in the voltage of the secondary battery: see Table 1).

As understood from FIG. 6, it is possible to shorten the charging time by switching to charging by the external power source 202 once the voltage of the secondary battery has passed the value where the charge current in the case of charging by the cell stack 102 becomes equal to the charge current in the case of charging by the external power source 202.

Here, description will be made for a method of calculating these types of charging times which are recorded in the charging time estimation table. The description here will cover how the full charging time will be calculated when the output of the cell stack 102 is Output 1.

First, calculation is made to obtain a full charging time in a case where the charge rate of the secondary battery 126 is 95%. Since the secondary battery 126 has a capacity of 20 Ah, the amount of charge necessary for bringing the charge rate of 95% to a target value of 98% is: (20×0.98)−(20×0.95)=0.6 Ah (ampere hours). The charge rate of 95% corresponds to 28 V in the voltage of the secondary battery (see Table 1). Since the voltage of 28V in the secondary battery in the case of Output 1 has a corresponding charge current of 6 A (see Table 2), the charging time for bringing the charge rate from 95% to 98% is: 0.6/6×60=6 minutes.

Next, calculation is made to obtain a full charging time in a case where the charge rate of the secondary battery 126 is 85%. The full charging time when the charge rate is 85% is obtained by adding a charging time for bringing the charge rate from 85% to 95% to the full charging time when the charge rate is 95%. The amount of charge necessary for bringing the charge rate from 85% to 95% is: (20×0.95)−(20×0.85)=2 Ah. The charge rate of 85% corresponds to 27 V in the voltage of the secondary battery (see Table 1). Since the voltage of 27 V in the secondary battery in the case of Output 1 has a corresponding charge current of 7 A (see Table 2), the charging time for bringing the charge rate from 85% to 95% is: 2/7×60≈17.1 minutes. Therefore, the full charging time when the charge rate is 85% is: 17.1+6=23.1 minutes.

By sequentially calculating the full charging time from a given charge rate to the 98% charge rate as described above, full charging time values shown in Table 2 are obtained. The full charging time values in the case of Output 2 are also calculated in the same method, and recorded in the charging time estimation table. Values of the minimum charging time and the switch-over charging time are also calculated in the same method but by using different target values (the charge rate values of 40%, 55% and 80% in the present preferred embodiment), and are recorded in the charging time estimation table.

The full charging time, the minimum charging time and the switch-over charging time are estimated by the CPU 148 from the charging time estimation table which is prepared in advance as described above, based on a voltage of the secondary battery and a charge current which are detected. If the charging time estimation table has the same values as the detected voltage of the secondary battery and charge current, the CPU 148 obtains a value for each type of the charging times, in correspondence to the detected voltage of the secondary battery and charge current, for use as a result of estimation. Specifically, for example, if the detection gives a value of 23 V as the voltage of the secondary battery and a value of 17 A as the charge current, the CPU 148 obtains a full charging time of 87.7 minutes, a minimum charging time of 11.8 minutes, and a switch-over charging time of 25.7 minutes, and these values will be used as a result of estimation.

On the other hand, if the charging time estimation table does not have the same values as the detected voltage of the secondary battery and charge current, then the CPU 148 calculates a value for each type of the charging times, using the detected voltage of the secondary battery and charge current as well as the charging time estimation table, and these calculated values will be used as a result of estimation.

Here, description will be made for how the charging times will be calculated when the charging time estimation table does not have the same values as the detected voltage of the secondary battery and charge current. The description here will cover a case of calculating a full charging time when the detected voltage of the secondary battery is 24.5 V and the detected charge current is 15 A.

First, a search is made of the charging time estimation table to find out a range of voltage of the secondary battery where the detected voltage of the secondary battery will fit. In the present example, since the detected voltage of the secondary battery is 24.5 V, it is found that the value will fit into a range from 24 V through 25 V.

Next, a value of the charge current which corresponds to the smallest value in the identified range and a value of the charge current which corresponds to the largest value in the identified range are obtained from the charging time estimation table for each case of Output 1 and Output 2. In the present example, the smallest value in the identified range is 24 V, and therefore the values of 13 A and 17 A are obtained correspondingly thereto. Likewise, the largest value in the identified range is 25 V and thus, values 11 A and 14 A are obtained correspondingly thereto. Then, a value of the charge current which corresponds to the detected voltage of the secondary battery is calculated for each case of Output 1 and Output 2 by using the charge current obtained for each case. Since 24.5 V is a mean value for the range from 24 V through 25 V, the charge current which corresponds to 24.5 V in the case of Output 1 is calculated as: (13+11)/2=12 A, whereas the charge current which corresponds to 24.5 V in the case of Output 2 is calculated as: (17+14)/2=15.5 A.

Along with the above, a value of the full charging time which corresponds to the smallest value in the identified range is obtained for each case of Output 1 and Output 2, and a value for the full charging time which corresponds to the largest value in the identified range is obtained for each case of Output 1 and Output 2, from the charging time estimation table. In the present example, the smallest value in the identified range is 24 V, and thus the values of 75.9 minutes and 54.3 minutes are obtained correspondingly thereto. Likewise, since the largest value in the identified range is 25 V, the values of 62.1 minutes and 43.7 minutes are obtained correspondingly thereto. Then, a value of the full charging time which corresponds to the detected voltage of the secondary battery is calculated for each case of Output 1 and Output 2, using the obtained full charging time. Since 24.5 V is a mean value for the range from 24 V through 25 V, the full charging time which corresponds to 24.5 V in the case of Output 1 is calculated as: (75.9+62.1)/2=69 minutes, whereas the full charging time which corresponds to 24.5 V in the case of Output 2 is calculated as: (54.3+43.7)/2=49 minutes.

Next, a difference between the detected charge current and each of the two calculated charge current values is calculated, and a ratio between the two differences are obtained. In the present example, the detected value of the charge current is 15 A, whereas the calculated values of the charge current are 12 A and 15.5 A. Therefore, the differences are: 15−12=3 A, and 15.5−15=0.5 A respectively, and the ratio between the two is 6:1.

Then, by using the ratio which is thus obtained; the differences between the two full charging time values thus calculated; and one of these two full charging time values; calculation is made to obtain a full charging time which corresponds to the detected voltage of the secondary battery and to the charge current. In the present example, the difference between the two full charging time values is: 69−49=20 minutes, and thus the full charging time which correspond to the detected voltage of the secondary battery and charge current is given by: 69−20/(6+1)×6 or 49+20/(6+1)×1≈51.9 minutes.

It should be noted here that if the detected voltage of the secondary battery is not an exact mean value in the identified range, the amount of difference from the mean value will be taken into account when calculating the charge current and the full charging time which correspond to the detected voltage of the secondary battery.

Also, if the detected charge current falls out of a range from the charge current which corresponds to the detected voltage of the secondary battery for the case of Output 1 to the charge current which corresponds to the detected voltage of the secondary battery for the case of Output 2, the calculation method is modified accordingly.

It should be noted here that it is possible to make the same kind of calculations for the minimum charging time and the switch-over charging time, by using the detected voltage of the secondary battery and charge current as well as the charging time estimation table.

As described, the CPU 148 calculates a value for each type of charging times by using the detected voltage of the secondary battery and charge current as well as the charging time estimation table, to supplement the charging time estimation table. Thus, it is possible to make an estimation for each type of charging times regardless of the value of the detected voltage of the secondary battery and charge current.

Next, description will be made for the recovery time estimation table stored in the memory 152.

As described above, if the temperature of the cell stack 102 is low, the charge rate of the secondary battery 126 drops (decreases) once, then recovers and then increases thereafter. The recovery time estimation table is used when the temperature of the cell stack 102 is lower than a predetermined temperature (for example, about 60° C. in the present example), in order to estimate a recovery time for the temperature of the cell stack 102 to attain the target temperature (for example, about 50° C.). In other words, the recovery time estimation table is used at a time other than the normal operation, to estimate the amount of recovery time for the temperature of the cell stack 102 to attain the target temperature. Table 3 shows an example of the recovery time estimation table.

TABLE 3

| | Cell stack Temperature (° C.) | | | | |
|---|---|---|---|---|---|
| | 10 | 20 | 30 | 40 | 50 |
| Recovery time (Output 1) (min) | 40.0 | 27.0 | 16.0 | 8.0 | 0.0 |
| Recovery time (Output 1) (min) | 30.0 | 20.0 | 12.0 | 6.0 | 0.0 |

Output 1: Cell stack output is 550 W.
Output 2: Cell stack output is 650 W.

The recovery time estimation table records values of the recovery time in correspondence to temperature values of the cell stack 102 and output values of the cell stack 102. Now, referring also to FIG. 7, compare Temperature 1 of the cell stack 102 and Temperature 2 of the cell stack 102 which is higher than Temperature 1. It is then understood that a recovery time T2 for Temperature 2 is shorter than a recovery time T1 for Temperature 1. The recovery time estimation table in Table 3 is obtained by measuring values of the recovery time needed for the temperature of the cell stack 102 to attain the target temperature, from the time when power generating operation is started at a certain selected temperature below about 60° C., and relating the measurement results to the selected temperature and the power generation output when this power generation is a normal operation.

Table 3 shows a recovery time value for every 10° C. in a range of 10° C. through 50° C. It should be noted, however, that in an actual recovery time estimation table, a recovery time value is recorded for every 1° C. for example. As an additional note, Table 3 shows a recovery time value for each case of Output 1 and Output 2, but in an actual recovery time estimation table, a recovery time value is recorded for every 1 W for example.

The CPU 148 obtains the recovery time from the recovery time estimation table, based on a result of detection by the temperature sensor 146 and the output of the cell stack 102 in the previous normal operation.

In the present preferred embodiment, the memory 152 defines the first and the second memories. The charge amount information detector includes the voltage detection circuit 46a and the CPU 148. The electric current information detector includes the electric current detection circuit 46b and the CPU 148. The notification unit includes the display 28b and the CPU 148. The temperature detector includes the temperature sensor 146 and the CPU 148. The setting unit includes the CPU 148 and the relay 168. The connection determination unit includes the CPU 148 and the charger 200. The switching unit includes the CPU 148 and the switch 200a. The CPU 148 also functions as the first estimation unit, the second estimation unit and the comparison unit. The CPU 148 further functions as the electric current estimation unit which estimates the charge current based on an output value of the cell stack 102 which is stored in the memory 152.

Next, description will cover an operation of power generation of the fuel cell system 100.

Referring to FIG. 2, aqueous methanol solution in the aqueous solution tank 116 is pumped by the aqueous solution pump 132, and is supplied directly to the anode 104b in each of the fuel cells 104 which constitute the cell stack 102, via the pipes P3, P4 and the anode inlet I1.

Meanwhile, gas (primarily containing carbon dioxide, vaporized methanol and water vapor) in the aqueous solution tank 116 is supplied via the pipe P15 to the catch tank 130. The methanol vapor and water vapor are cooled in the catch tank 130, and the aqueous methanol solution obtained in the catch tank 130 is returned via the pipe P16 to the aqueous solution tank 116. On the other hand, gas (containing carbon dioxide, non-liquefied methanol and water vapor) in the catch tank 130 is supplied via the pipe P17 to the air chamber 136.

Air which is introduced by the air pump 134 via the pipes P7 enters an air chamber 136, where it is silenced. The air which was introduced to the air chamber 136 and gas from the catch tank 130 flow via the pipe P8 to the air pump 134, and then through the pipe P9 and the cathode inlet 13, into the cathode 104c in each of the fuel cells 104 which constitute the cell stack 102.

At the anode 104b in each fuel cell 104, methanol and water in the supplied aqueous methanol solution chemically react with each other to produce carbon dioxide and hydrogen ions. The produced hydrogen ions flow to the cathode 104c via the electrolyte film 104a, and electrochemically react with oxygen in the air supplied to the cathode 104c, to produce water (water vapor) and electric energy. Thus, power generation is performed in the cell stack 102. As described above, the output from the cell stack 102 increases as the temperature increases. The fuel cell system 100 attains a state of normal operation when the cell stack 102 has attained a temperature of about 60° C., for example.

Carbon dioxide produced at the anode 104b of each fuel cell 104, and aqueous methanol solution including unused methanol are heated by the heat from the electrochemical reactions. The carbon dioxide and the aqueous methanol solution flow from the anode outlet I2 of the cell stack 102, through the pipe P5 into the radiator 108a, where they are cooled. The cooling of the carbon dioxide and the aqueous methanol solution is facilitated by driving the fan 110. The carbon dioxide and the aqueous methanol solution which have been cooled then flow through the pipe P6, and return to the aqueous solution tank 116.

Meanwhile, most of the water vapor produced on the cathode 104c in each fuel cell 104 is liquefied and discharged in the form of water from the cathode outlet I4 of the cell stack 102, with saturated water vapor being discharged in the form of gas. The water vapor which was discharged from the cathode outlet I4 is supplied via the pipe P10 to the radiator 108b, where it is cooled and its portion is liquefied as its temperature decreases to or below the dew point. The liquefying operation of the water vapor by the radiator 108b is facilitated by operation of the fan 112. Discharge from the cathode outlet I4, which contains water (liquid water and water vapor), carbon dioxide and unused air, is supplied via the pipe P10, the radiator 108b and the pipe P11, to the water tank 118 where water is collected, and thereafter, discharged to outside via the pipe P12.

At the cathode 104c in each fuel cell 104, the vaporized methanol from the catch tank 130 and methanol which has moved to the cathode 104c due to crossover react with oxygen in the platinum catalyst layer, thereby being decomposed to harmless substances of water and carbon dioxide. The water and carbon dioxide which are produced from the methanol are discharged from the cathode outlet I4, and supplied to the water tank 118 via the radiator 108b. Further, water which has moved due to water crossover to the cathode 104c in each fuel cell 104 is discharged from the cathode outlet I4, and supplied to the water tank 118 via the radiator 108b.

The fuel cell system 100 as described above causes the cell stack 102 to generate electric power and charge the secondary battery 126 as necessary.

Next, description will be made for a charging process in the fuel cell system 100 from the time of operation start command to the time of operation stop command, with reference to FIG. 8.

When the main switch 142 is turned ON, an operation start command is given to the CPU 148, and the fuel cell system 100 starts its operation. After the operation is started, the CPU 148 detects a voltage of the secondary battery based on a detection signal from the voltage detection circuit 46a, and determines whether or not the detected voltage of the secondary battery is lower than a predetermined voltage (24 V in the present example). In other words, a determination is made as to whether or not the charge rate of the secondary battery 126 is lower than 40% (see Table 1) (Step S1). If the charge rate is lower than 40%, the CPU 148 causes the system components such as the aqueous solution pump 132 and the air pump 134 to be driven by power from the secondary battery 126, thereby starting power generation in the cell stack 102 (Step S3).

Next, the CPU 148 determines whether or not the temperature of the cell stack 102 is not lower than a predetermined temperature (60° C. in the present example) based on a detection signal from the temperature sensor 146. In other words, a determination is made whether or not the fuel cell system 100 is in normal operation (Step S5). If it is in normal operation, the CPU 148 detects a cell stack voltage and a cell stack current based on detection signals from the voltage detection circuit 156 and the electric current detection circuit 158, and calculates an output when the cell stack voltage is 23 V (Step S7). Then, the CPU 148 causes the memory 152 to store the calculated output as an output in normal operation (Step S9).

Thereafter, as charging to the secondary battery 126 progresses and Step S11 determines that the secondary battery 126 is fully charged (98% charge rate), the system components are stopped and generation in the cell stack 102 is stopped (Step S13).

In the fuel cell system 100, the secondary battery 126 is charged after the main switch 142 is turned OFF, in order to ensure a reliable shift to normal operation the next time the system is operated. In other words, the secondary battery 126 is charged after an operation stop command is issued.

It should be noted here that in the above-described process, description was made for a case where the output of the cell stack 102 is calculated by using a detected cell stack current when Step S7 determines that the cell stack voltage is 23 V. However, the method for obtaining the output of the cell stack 102 is not limited to this. For example, the cell stack current for the 23 V cell stack voltage may be obtained based on a cell stack current detected when the cell stack voltage is not 23 V and this particular cell stack voltage, from a table which is stored in the memory 152 in advance. Then, it is possible to calculate an output of the cell stack 102 by obtaining a product of the cell stack current and the cell stack voltage (23 V). Also, an output of the cell stack 102 for the 23 V cell stack voltage may be obtained based on a cell stack current detected when the cell stack voltage is not 23 V and this particular cell stack voltage, from a table which is stored in the memory 152 in advance.

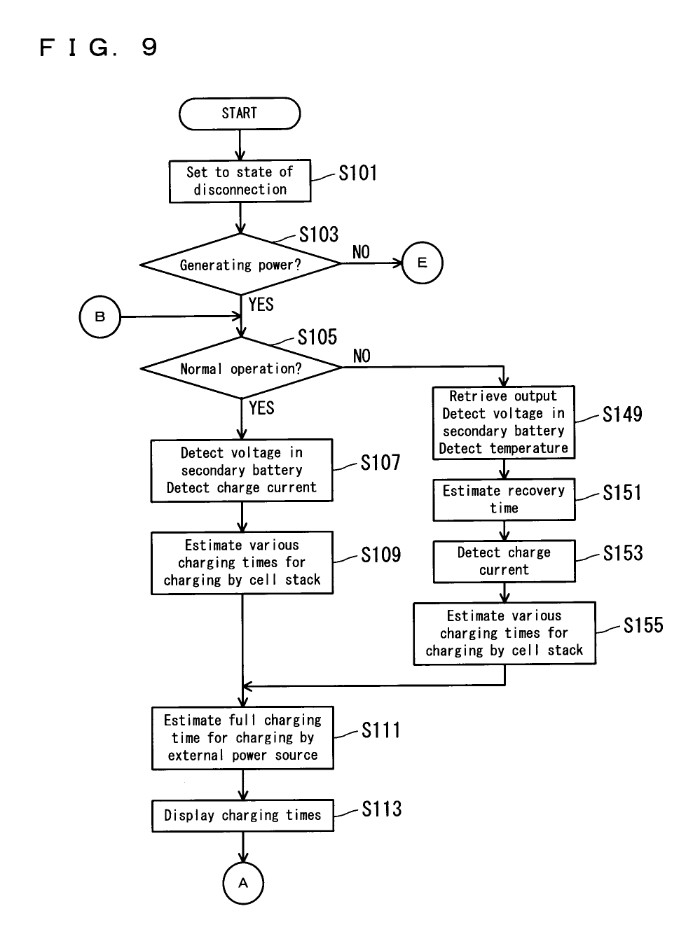

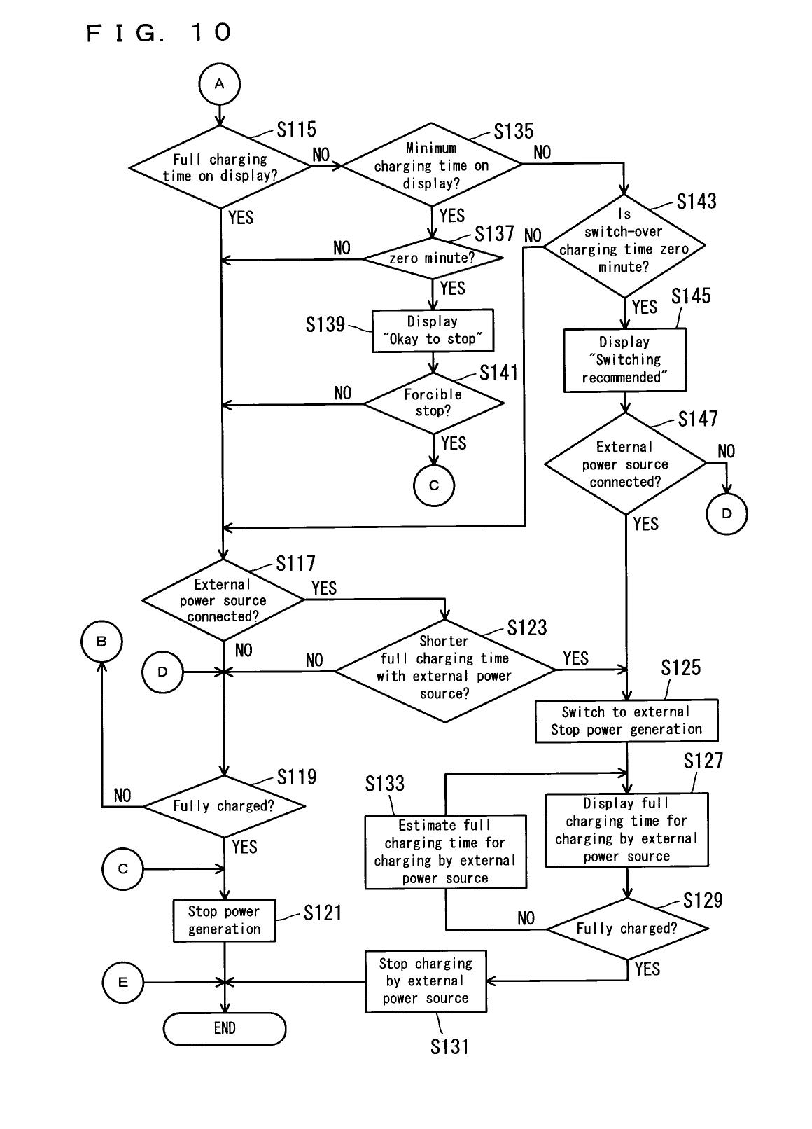

Next, description will be made for a charging process in the fuel cell system 100 after issuance of operation stop command, with reference to FIG. 9 and FIG. 10.

First, as the main switch 142 is turned OFF and the CPU 148 is given an operation stop command, the relay 168 is turned OFF, setting the system into a state of disconnection where the cell stack 102 and the electric motor 40 are disconnected from each other (Step S101). Along with this, the CPU 148 determines whether or not the cell stack 102 is generating power (Step S103). If the cell stack 102 is generating power, the CPU 148 determines whether or not the temperature of the cell stack 102 is not lower than a predetermined temperature (60° C. in the present example), based on a detection signal from the temperature sensor 146. In other words, a determination is made whether or not the fuel cell system 100 is in normal operation (Step S105). If it is in normal operation, the CPU 148 detects a voltage of the secondary battery based on a detection signal from the voltage detection circuit 46a, and a charge current as well, based on a detection signal from the electric current detection circuit 46b (Step S107).

Next, the CPU 148 retrieves the charging time estimation table (see Table 2) from the memory 152, and estimates, as has been described earlier, a full charging time, a minimum charging time and a switch-over charging time based on the detected voltage of the secondary battery and charge current obtained in Step S107 (Step S109).

Also, the CPU 148 estimates a full charging time for the case of charging by the external power source 202, based on the voltage of the secondary battery detected in Step S107 and a predetermined charge current (rated current) of the external power source 202 (Step S111). Step S111 retrieves the charge-rate/battery-voltage correspondence table from the memory 152, and detects a charge rate which corresponds to the voltage of the secondary battery detected in Step S107. Then, calculations are made to obtain the amount of charging to be made, from the charge rate, a charge rate (98%) for a fully charged state, and a capacity (20 Ah) of the secondary battery 126. Then, by dividing the amount of charging by a predetermined charge current (11 A) for the case of charging by the external power source 202, the full charging time is obtained.

Next, the CPU 148 causes the display 28b to display the charging times which were estimated in Steps S109 and S111 (Step S113). In this step, the human driver of the vehicle is notified with the full charging time, the minimum charging time and the switch-over charging time. In the present example, the full charging time estimated in Step S109 and the full charging time estimated in Step S111 are displayed first, and thereafter, the display on the display 28b is switched each time the display switching button 30a is pressed on the input portion 28c. Specifically, if the full charging time is on the display, pressing the display switching button 30a switches the display to the minimum charging time, whereas if the minimum charging time is on the display, switching is made to display the switch-over charging time, and if the switch-over charging time is on the display, switching is made to display the full charging time.

Next, if Step S115 determines that a full charging time is on the display 28b and Step S117 determines that the external power source 202 is not connected, the process returns to Step S105 until Step S119 determines that full charging (98% charge rate) has been achieved. On the other hand, if Step S119 determines that full charging has been achieved, the CPU 148 stops the system components, stops power generation in the cell stack 102 (Step S121), and finishes the charging process after issuance of operation stop command.

On the other hand, if Step S117 determines that there is an input of an external power source connection signal from the charger 200, the CPU 148 determines that the external power source 202 is connected, and then makes a comparison between the full charging time which was estimated in Step S109 and the full charging time which was estimated in Step S111 (Step S123). In other words, comparison is made between the full charging time necessary when charging is performed by the cell stack 102 and the full charging time necessary when charging is performed by the external power source 202. Then, if it is found that charging by the external power source 202 will take a shorter full charging time, the CPU 148 stops power generation in the cell stack 102, and turns ON the switch 200a in the charger 200 to switch to the charging by the external power source 202 (Step S125).

Next, the CPU 148 causes the display 28b to display only the full charging time in the case of charging by the external power source 202 which was estimated in Step S111 (Step S127). Then, when Step S129 determines that full charging has been achieved, the CPU 148 turns OFF the switch 200a of the charger 200, thereby stopping the charging by the external power source 202 (Step S131), and finishes the charging process after issuance of operation stop command. Until Step S129 determines that full charging has been achieved, the process estimates a full charging time for the case of charging by the external power source 202 (Step S133), and then returns to Step S127.

If Step S115 does not determine that the full charging time is on the display and Step S135 determines that the minimum charging time is on the display, and if Step S137 determines that the minimum charging time is 0 minute, the CPU 148 causes the display 28b to display a message, for example, which indicates that the charging process after the issuance of operation stop command may be stopped (Step S139). Then, if Step S141 determines that the stop button 30b on the input portion 28c is pressed, i.e., if there is an input of a forcible-stop command, the process moves to Step S121. If Step S137 determines that the minimum charging time is not 0 minutes, the process moves to Step S117. Likewise, if Step S141 determines that there is not an input of a forcible-stop command, then the process moves to Step S117.

If Step S135 determines that the switch-over charging time is on display and Step S143 determines that the switch-over charging time is 0 minutes, the CPU 148 causes the display 28b to display a message, for example, indicating that charging time will be shortened if switching is made to charging by the external power source 202 (Step S145). Then, if Step S147 determines that the external power source 202 is connected, the process moves to Step S125. On the other hand, if Step S147 does not determine that the external power source 202 is connected, the process moves to Step S119.

If Step S105 does not determine that the fuel cell system 100 is in normal operation, the previous output of the cell stack 102 under normal operation, which was stored in the memory 152 in the process shown in FIG. 8, is retrieved, and detection is made for a voltage of the secondary battery and a temperature of the cell stack 102 (Step S149). Then, the CPU 148 estimates a recovery time for the temperature of the cell stack 102 to attain the target temperature, by using the output of the cell stack 102 which was retrieved from the memory and the temperature of the cell stack 102 (Step S151).

In Step S151, the CPU 148 estimates a recovery time from the recovery time estimation table (see Table 3), based on the output of the cell stack 102 which was retrieved in Step S149 and the detected temperature of the cell stack 102.

If the system is in the state of disconnection, power consumption by the electric motor 40 is negligible. In Step S153, power supply to the secondary battery 126 is calculated, by first subtracting the system components' power consumption (150 W in the present example) from the retrieved output of the cell stack 102. In the cell stack 102 and the secondary battery 126 are connected in parallel to each other, the voltage in the cell stack and the voltage in the secondary battery are substantially equal to each other. Therefore, it is possible to calculate the charge current by dividing the calculated power supply by the predetermined cell stack voltage (23 V).

Next, the amount of change in the charge rate during the recovery time is estimated. Since there is a proportional relationship between (the charge current×time) and (the amount of change in the charge rate), it is possible to make the estimation by multiplying the charge current which was detected in Step S153 by the recovery time. The charge rate and the voltage of the secondary battery after the lapse of the recovery time can be obtained by making reference to the charge-rate/battery-voltage correspondence table, and on the basis of the estimated amount of change in the amount of charge as well as the voltage of the secondary battery detected in Step S149. Then, based on the voltage of the secondary battery after the lapse of the recovery time and the charge current detected in Step S153, estimation is made for a full charging time, a minimum charging time and a switch-over charging time, from the charging time estimation table (see Table 2). Thereafter, the recovery time estimated in Step S153 is added to the full charging time, the minimum charging time and the switch-over charging time to modify these values, and the obtained values are displayed as a result of estimation in Step S113 (Step S155).

If Step S103 determines that the cell stack 102 is not generating power, this means that the charge rate of the secondary battery 126 is not lower than 40% (see FIG. 8), and thus it is possible to reliably shift the fuel cell system 100 to normal operation in the next operation. Therefore, the process is brought to an end without charging the secondary battery 126 if Step S103 determines that the cell stack 102 is not generating power.

According to the fuel cell system 100 as described, it is possible, after an issuance of an operation stop command, to estimate the full charging time, the minimum charging time and the switch-over charging time based on the voltage of the secondary battery, the charge current and the charging time estimation table, and to notify these to the vehicle driver. This allows the driver to make a schedule for the next activity during the charging process after issuance of operation stop command, and thus it is possible to improve driver convenience.

Estimating the charging time after being switched to the state of disconnection makes it possible to make the estimation on the charging time with small fluctuation in the charge current. Therefore, it is possible to improve reliability of a result of estimation. Also, because the charging time estimation table has a record of the full charging time, the minimum charging time and the switch-over charging time in correspondence to changes in the charge current, it is possible to improve accuracy in the result of estimation. The accuracy in the result of estimation can be improved by preparing the charge current values and various charging time values in correspondence to the voltage of the secondary battery at as short an interval as possible in the charging time estimation table.

If the system is not in normal operation, the charging time value for each type of charging times which were estimated by using the charging time estimation table is added to the recovery time which was estimated by using the recovery time estimation table. This makes it possible to notify reliable charging times even if the system is not in normal operation.

By notifying the full charging time, the minimum charging time and the switch-over charging time, the driver can choose one charging time for completing the charging process after issuance of operation stop command, and this further improves driver convenience.

By notifying the minimum charging time, the driver can finish the charging process after issuance of operation stop command in a minimum necessary length of charging time. Also, by notifying the switch-over charging time, the driver can have an option of switching from charging by the cell stack 102 to charging by the external power source 202 for quick charging of the secondary battery 126 to a full extent.

By notifying the full charging time for the case of charging by the cell stack 102 and the full charging time for the case of charging by the external power source 202, the driver can choose which of the charging methods to use, and this further improves driver convenience.

If the fuel cell system 100 is connected with the external power source 202, and it is estimated that charging by the external power source 202 requires a shorter full charging time than charging by the cell stack 102, automatic switching is made from charging by the cell stack 102 to charging by the external power source 202. This makes it possible to shorten the time necessary for the charging process after issuance of operation stop command.

Normally, it is assumable that the driver of the motorbike 10 already has a schedule for the time after his arrival at his destination before he arrives at the destination. Therefore, preferred embodiments of the present invention which are capable of notifying the time required for the charging process after issuance of an operation stop command can be used suitably to transportation equipment such as the motorbike 10.

It should be noted here that the output data of the cell stack 102 which is stored in the memory 152 for retrieval in Step S149 in FIG. 9 is not limited to data from the previous operation, but may be older data.

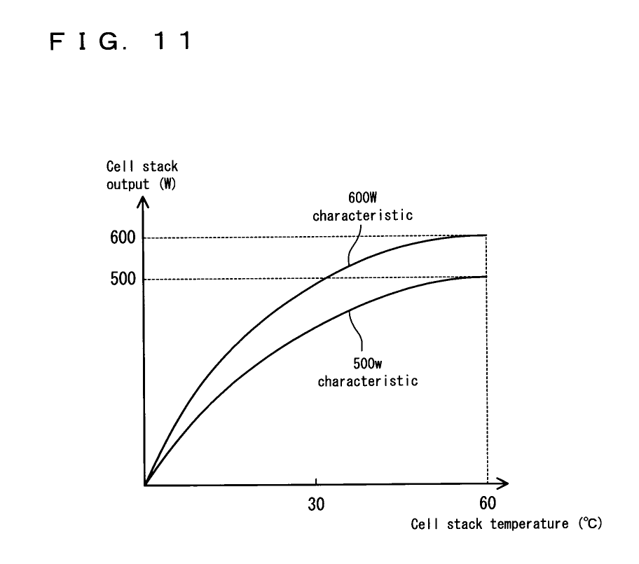

The output of the cell stack 102 in the previous operation, i.e., data which is retrieved from the memory 152 in Step S149 in FIG. 9, may not be used. For example, detection may be made for an output at a temperature lower than 60° C. (before shifting to normal operation) in the current operation so that this output value is used for estimating an output at the time of normal operation. In this case, for example, data which represents two curves shown in FIG. 11 is stored in advance in the memory 152. One of the two curves is a 500 W characteristic curve which shows correspondence between the cell stack temperature and the cell stack output where the cell stack output is 500 W in normal operation. The other curve is a 600 W characteristic curve which shows correspondence between the cell stack temperature and the cell stack output where the cell stack output is 600 W in normal operation. Based on comparison of these two curves with the temperature and the output of the cell stack 102 in the current operation, estimation is made for an output at the time of normal operation. Specifically, an output at the time of normal operation is estimated by making reference to FIG. 11 and based on positional relationships of the output corresponding to the temperature of the cell stack 102 in the current operation and the output values on the two curves at the detected temperature. Then, the obtained output of the cell stack 102 is used to calculate the amount of heat generated by the cell stack 102. In this process, for example, the obtained output of the cell stack 102 is entered to the following mathematic expression: The Amount of Heat Generated=(Output/Power Generation Efficiency)−Output, to obtain the amount of heat generated by the cell stack 102. In this example, Power Generation Efficiency is set to about 0.4, for example.

Then, the amount of heat generated by the cell stack 102 and the temperature are entered to Mathematical Expression 1 to estimate the recovery time.

$$Recovery Time = \frac{\begin{matrix}Thermal Capacity \times \\ ( Target Temp - Current Temp )\end{matrix}}{Amount of Heat Generated} \times Coefficient \qquad Mathematical Expression 1$$

Thermal Capacity The amount of heat necessary for raising the temperature of the system by 1° C.
Amount of Heat Generated: The amount of heat generated by the cell stack per unit time (one minute)

In Mathematical Expression 1, for example, Thermal Capacity is 20 KJ/° C., the amount of heat generation is 1/30 KW, and the target temperature is 50° C. The cell stack output and the amount of heat generation have a certain relationship, with a coefficient selected in accordance with a temperature difference between the current temperature and an ambient temperature. When setting the coefficient, the ambient temperature may be a detected temperature or may be a predetermined temperature.

Then, a charge current is detected from an estimated output as described for Step S153, a charging time is estimated on the basis of the charge current and the voltage of the secondary battery as described for Step S155, and then a result of estimation is obtained by adding the estimated charging time to the estimated recovery time.

With the arrangement described above, it is possible to estimate the recovery time without using the recovery time estimation table, and thus it is possible to notify a result of estimation which is obtained by adding the recovery time to the charging time.

In this case, an output detector which detects the output of the cell stack 102 includes the CPU 148, the voltage detection circuit 156 and the electric current detection circuit 158.

In the example procedure described above, description was made for a case where the charging time which comes on the display is switched to another when the display switching button 30a is pressed. However, any method of displaying the charging time may be utilized. For example, the display 28b may display the full charging time, the minimum charging time and the switch-over charging time simultaneously. Also in the above, description was made for a case where the full charging time in the case of charging by the cell stack 102 (the full charging time estimated in Step S109) and the full charging time in the case of charging by the external power source 202 (full charging time estimated in Step S111) are displayed simultaneously. However, these may be displayed separately from each other.

Further, in the example procedure described above, description was made for a case where the system is brought to an end without charging the secondary battery 126 if Step S103 determines that the cell stack 102 is not generating power. However, the present invention is not limited to this. For example, there may be an arrangement that when the cell stack 102 is not generating, the driver is asked if he wants the system to be charged or not. In this arrangement, the system shuts down if the driver gives a command not to charge, whereas the system will charge if the driver gives a command to charge.

In the preferred embodiment described above, description was made for a case where detection of the charge rate is based upon the voltage of the secondary battery. However, any method may be utilized to detect the charge rate (the amount of charging). For example, the amount of charge may be detected by accumulating the amount of charging and the amount of discharging of the secondary battery.

In the preferred embodiment described above, description was made for a case where the CPU 148 detects the charge current directly, as electric current information regarding the charge current, based on a detection signal from the electric current detection circuit 46b. However, the present invention is not limited to this. For example, the output (electric power) of the cell stack 102 or the cell stack current may be detected as the electric current information regarding the charge current.

If the output (electric power) of the cell stack 102 is used as the electric current information regarding the charge current, power consumption by the system component, etc., is stored in the memory 152 in advance, and the power consumption values are subtracted from the output of the cell stack 102, to calculate the output to the secondary battery 126. Then, this output to the secondary battery 126 is divided by the cell stack voltage, to calculate the charge current. The power consumption by the system components, etc., may not be stored in advance in the memory 152, but may be obtained at the time of detecting the charge current. If the output (electric power) of the cell stack 102 is used as the electric current information regarding the charge current, the electric current information detector includes the CPU 148, the voltage detection circuit 156 and the electric current detection circuit 158.

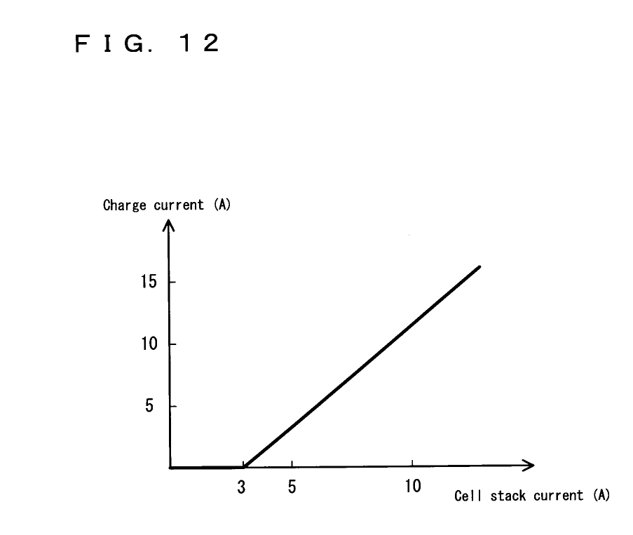

If the cell stack current is used as the electric current information regarding the charge current, electric current consumption by the system components, etc., is stored in the memory 152 in advance, and the electric current consumption is subtracted from the cell stack current, to calculate the charge current. As another arrangement, a table in FIG. 12, which shows a relationship between the cell stack current and the charge current may be stored in the memory 152, so that reference can be made to this table in order to obtain the charge current from the cell stack current. The electric current consumption by the system components, etc., may not be stored in advance in the memory 152, but may be obtained at the time of detecting the charge current. If the cell stack current is used as the electric current information regarding the charge current, the electric current information detector includes the CPU 148 and the electric current detection circuit 158.

In the preferred embodiments described above, description was made for a case where the first target value is set to an approximately 98% charge rate, and the second target value is set to an approximately 40%, 55% and 80% charge rate, for example. However, the first target value and the second target value may be set to any value if the first target value is greater than a charge rate value which allows the system to be shifted to the normal operation.

In the preferred embodiments described above, description was made for a case where estimation is made for the charging time in the state of disconnection. However, the present invention is not limited to this. The charging time may be estimated in the state of connection.

In the preferred embodiments described above, description was made for a case where estimation of the charging time is preferably made after an issuance of operation stop command. However, the present invention is not limited to this. For example, the charging time may be estimated and notified in the period from the operation start command to the operation stop command.

In the preferred embodiment described above, description was made for a case where estimation of the full charging time, the minimum charging time and the switch-over charging time is made by using the charging time estimation table (see Table 2). However, the present invention is not limited to this. For example, the memory 152 may store the charge-rate/battery-voltage correspondence table (see Table 1) which corresponds the charge rate to the voltage of the secondary battery; the capacity of the secondary battery 126; and the charge rate which represents full charge, so that the charging time can be calculated on the basis of the detected voltage of the secondary battery and charge current. In this case, the amount of charge necessary is calculated from data stored in the memory 152 and a detected voltage of the secondary battery. Then, the obtained amount of charge is divided by the charge current to calculate the charging time.

In the preferred embodiments described above, description was made for a case where the voltage of the secondary battery is used as the charge amount information regarding the amount of charge in the secondary battery 126. However, the present invention is not limited to this. The charge amount information regarding the amount of charge in the secondary battery 126 may be defined by the amount of charge or the charge rate. For example, if the amount of charge is used, the detected amount of charge is subtracted from the capacity of the secondary battery 126, to calculate the amount of charge for the charging operation, and the charging time is calculated by dividing the amount of charge by the detected charge current. If the charge rate is used, the charge rate is multiplied by the capacity of the secondary battery 126 to calculate the amount of charge. Then, the calculated amount of charge is subtracted from the capacity of the secondary battery 126 to obtain the amount of charge for the charging operation, and the charging time is calculated by dividing the amount of charge by the detected charge current.

It should be noted here that the notification unit may be configured to use a speaker, for example, so as to notify in the form of voice message, etc.

Also, the fuel cell system according to various preferred embodiments of the present invention can be used suitably not only to motorbikes but also any other transportation equipment such as automobiles, marine vessels, etc.

The present invention is applicable to stationary-type fuel cell systems, and further, to portable-type fuel cell systems which may be incorporated in personal computers, mobile devices, etc.

The present invention being thus far described and illustrated in detail, it should be noted that these description and drawings only represent examples of the present invention, and should not be interpreted as limiting the present invention. The scope of the present invention is only limited by words used in the accompanied claims.

What is claimed is:

1. A fuel cell system comprising:
a fuel cell;
a secondary battery which is charged by the fuel cell;
a charge amount information detector arranged to detect charge amount information regarding an amount of charge in the secondary battery;
an electric current information detector arranged to detect electric current information regarding an electric current flowing in the secondary battery;
an estimation unit arranged to estimate a charging time for the amount of charge in the secondary battery to reach a target value, based on a result of detection by the charge amount information detector and a result of detection by the electric current information detector; and
a notification unit arranged to notify a result of estimation by the estimation unit.

2. The fuel cell system according to claim 1, further comprising a setting unit arranged to set one of a state of connection in which the fuel cell is connected with an external load and a state of disconnection in which the fuel cell is not connected with the external load,
wherein the estimation unit estimates the charging time after the setting unit has made a setting into the state of disconnection.

3. The fuel cell system according to claim 1, further comprising:
a temperature detector arranged to detect a temperature of the fuel cell;
a first memory arranged to store an output of the fuel cell; and
a second memory arranged to store a recovery time estimation table that shows correspondence between the temperature of the fuel cell, the output of the fuel cell and a recovery time for the temperature of the fuel cell to attain a target temperature;
wherein the estimation unit estimates the recovery time based on a result of detection by the temperature detector, the output stored in the first memory and the recovery time estimation table stored in the second memory; detects the electric current information based on the output stored in the first memory; estimates the charging time based on the detected electric current information, the estimated recovery time and a result of detection by the charge amount information detector; and obtains the estimated result by adding the estimated recovery time to the estimated charging time, if a result of detection by the temperature detector is lower than a predetermined temperature.

4. The fuel cell system according to claim 1, wherein the target value includes a first target value which is greater than a value at which the fuel cell can make a shift to normal operation where the fuel cell can generate power constantly, and a second target value which is smaller than the first target value.

5. The fuel cell system according to claim 4, wherein the second target value is set to a value at which shifting to the normal operation is possible.

6. The fuel cell system according to claim 4, wherein the second target value is set to a value at which an electric current flow in the secondary battery in a case of charging by an external power source which is capable of charging the secondary battery with a predetermined electric current is identical with an electric current flow in the secondary battery in a case of charging by the fuel cell.

7. The fuel cell system according to claim 1, wherein the estimation unit is a first estimation unit, the fuel cell system further comprising a second estimation unit which estimates the charging time for a case of charging by an external power source which is capable of charging the secondary battery with a predetermined electric current, based on a result of detection by the charge amount information detector and the predetermined electric current,
wherein the notification unit notifies a result of estimation by the first estimation unit and a result of estimation by the second estimation unit.

8. The fuel cell system according to claim 7, further comprising:
a connection determination unit arranged to determine whether or not the external power source is connected;
a comparison unit arranged to compare a result of estimation by the first estimation unit and a result of estimation by the second estimation unit; and
a switch arranged to switch from charging by the fuel cell to charging by the external power source based on a result of determination by the connection determination unit and a result of comparison by the comparison unit.

9. Transportation equipment comprising the fuel cell system according to claim 1.

10. A method for operating a fuel cell system including a fuel cell and a secondary battery which is charged by the fuel cell, the method comprising:
a step of charging the secondary battery by the fuel cell;
a step of detecting charge amount information regarding an amount of charge in the secondary battery;
a step of detecting electric current information regarding an electric current flowing in the secondary battery;
a step of estimating a charging time for the amount of charge in the secondary battery to attain a target value based on the charge amount information and the electric current information which are detected; and
a step of notifying the estimated charging time.
